(19) United States
(12) Patent Application Publication
(10) Pub. No.: US 2015/0088650 A1
(43) Pub. Date: Mar. 26, 2015

(54) SYSTEM AND METHOD FOR PURCHASING BY SOCIAL NETWORK STATUS UPDATE OR POST

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 14/464,628

(22) Filed: Aug. 20, 2014

Related U.S. Application Data
(60) Provisional application No. 61/881,246, filed on Sep. 23, 2013.

(51) Int. Cl. G06Q 30/02; G06Q 50/00; G06Q 30/06; G06F 17/30

(52) U.S. Cl. CPC G06Q 30/0256; G06F 17/30684; G06Q 50/01; G06Q 30/0269; G06Q 30/0613
USPC 705/14.54

(57) ABSTRACT

A system and method facilitating online purchases within social network environments comprises posting or re-posting a string of characters affiliated with a product on a social network newsfeed, page, or as a status update. The system includes a search engine monitoring posts for the string of characters indicating intention to purchase and a payment processing component. The purchase is completed without further entry of information by the user if the user's financial data is previously available. The system may include a customer validator, payment information validator, electronic receipt generator, error detection components, and may communicate with an external merchant account. The method allows an internet merchant or marketer to offer a product for sale by posting a string of characters that can be purchased by users of a common social networking platform by posting or re-posting the string of characters.

### CROSS-REFERENCE TO RELATED APPLICATIONS

This application claims the priority and benefit of co-pending U.S. Provisional Application No. 61/881,246 filed Sep. 23, 2013 in the names of the same inventors, Rey Pasinli and T. Jason Taylor.

### FIELD OF THE INVENTION

The present invention relates to network and internet commerce and social networking. More particularly, the present invention relates to social commerce which combines these two fields. Most particularly, the present invention relates to the encouragement and facilitation of purchases and the processing of payments made in a social commerce environment.

### BACKGROUND

One of the great benefits of the internet age was discovered to be that it could be used for purchases of all sorts without geographic limitation to traditional brick and mortar stores. This lead to increased variety of offerings to the individual internet-savvy consumer along with better prices due to increased competition, fewer middlemen, reduced overhead, and resale, not to mention savings of gas and time compared to traditional in-person shopping in brick and mortar establishments. Websites likely eBay, Amazon, and Craigslist proliferated and payment processors like PayPal took care of the backend in an era of internet commerce.

More recently, the connectivity aspect of the internet has emerged as another benefit in the form of social networking websites, apps and services. As used herein the term and adjective “social networking” as used with any type of website/forum/platform is used broadly to include all variations of networking to include, for example, professional networking (for example LinkedIn®). In increasing numbers individuals are signing up to join various social networking platforms and sharing information about themselves, keeping in touch with existing friends/classmates/family/colleagues/coworkers and other real-life connections, and forging new relationships with unknown individuals across the globe or friends-of-friends and higher order connections that may or may not leave the virtual realm to meet face-to-face.

The benefits of social network are numerous in that it provides an easy way to stay in touch with many people simultaneously, serves as a news resource, lets certain things be known to everyone (or selected groups) in the user's network without taking the time to tell each person, provides a platform to ask questions with real people answering, allows the user to answer other users' questions as a starting point for a future relationship, and provides an outlet to advertise for free or low cost.

More recently, internet commerce has begun to merge with social networking in the form of individuals making purchase decisions and being directed to purchase products of interest based on referrals from friends or connections in a social networking forum. Even before the internet and still today many individuals make purchasing decisions based on things which they see and like from or belonging to friends, relatives, and co-workers and based on talking to these individual people about their experiences with a particular product. With more people spending more time looking at a computer, tablet computer, smart phone, or other internet connected device through which they can check-in with their social networking forums of interest, it comes as no surprise that purchase decisions of today and of the future will be strongly influenced by what's going on in social networking forums. Specifically, if an individual is online on any of their preferred social networking websites and they see a friend, someone whom they follow, or a follower, a connection, a fellow group member, or other direct or indirect contact posting about something which the user notices and likes, or which they recommend, the user becomes more prone to interest themselves. Just the mere fact that the connection purchased something, may make individuals interested in the product. The typical individual will then ask themselves, at least subconsciously, whether they too need, want, or should get that product.

The drawback to contemporary means of sharing purchase information and making product recommendations online is that it while it may increase attention, curiosity, and general interest in a product it falls short of actually streamlining subsequent follow-on purchases provoked by the share or recommendation. To a large extent, individual internet activity (particularly that occurring in social networking forums) is controlled by factors such as distractibility and spontaneity. Further, all activity is governed or impacted by time. This time factor is attenuated when participating in an online social network in many contexts including on a mobile platform while commuting or when in class, at a meeting, or at work and checking in quickly for a break.

Presently if an individual wants to share information about a purchase to their contacts on a social network they may, for example, post a link to the company or product website. In some cases, at or after check-out, the product website may prompt the user to share the fact that they purchased the product and leave it at that. While connections may notice this information and may note to look into that product or website when they have time or even visit the website and start to read about the product, more likely the connections notice and then get distracted without taking any immediate action. In many contexts of usage, even if an individual actually wants the product they may not have the time to actually visit the website, enter their credit card information, etc. For example, this may occur if an individual is in class or at a board meeting and supposed to at least appear to be paying attention and thus doesn't want to pull out a credit card. Even third party secure payment processing solutions (e.g. PayPal) take more than a few screens and steps to purchase.

It would be desirable to provide a simple yet functional system and method for quickly and seamlessly purchasing a product mentioned or promoted in a post or status update on a social networking website that overcomes these challenges. For example, a system and method that encourages and facilitates subsequent follow-on purchases and processes payments before the individual subsequent purchaser gets distracted or decides not to purchase. It would be desirable to provide such a system and method that are easily understood and used in practice and that do not require a purchaser to leave the social networking forum or even to leave the newsfeed or other part of the forum where they initially noticed the product. Finally, it would be desirable to track all of this data about purchases generated through social networking websites and through particular users. The present invention meets these and other needs.

### SUMMARY OF THE INVENTION

The above-discussed disadvantages of the reference art are overcome by the system and method of the present invention that provides a simple, yet elegant solution to quickly purchasing a specific product/service offered online without leaving the social network environment or having to enter payment information more than once during initial sign-up.

According to a first aspect, embodiment, objective and advantage, the invention provides a system for facilitating an online purchase transaction of a product within a social network environment by way of an individual social network user posting a post of one or more characters on a social network newsfeed, webpage, or as a status update. The system includes a search engine or scanner for monitoring social network posts, the search engine or scanner configured to search one or more posts of a particular user or group(s) of users for a particular string of characters that indicates a user's intent to purchase a product; and a payment processing component. The payment processing component includes a customer validator configured to check the individual social network user's unique social network handle or user account identifier against a list of existing registered member accounts. If the handle or identifier matches any one of existing registered member accounts the online purchase transaction can be accomplished without the individual social network user entering any additional payment information.

Furthermore, the customer validator is configured to prompt the individual social network user to sign-up for a payment processing account if the handle or identifier does not match any of the existing registered member accounts. The payment processing component is configured to receive, store, and associate bank or credit card information of a member with a member account for use in online purchase transactions on one or more social networking website. The payment processing component is configured to extract data related to a user account from the social networking website to create a new member account so that a new member of a payment processor does not have to manually input each piece of data.

The system may also include a payment information validator as part of the payment processing component. A new member account cannot be confirmed until valid payment information is entered. The payment information validator is configured to tokenize and securely store valid payment information in association with a particular member. The payment processing component may be configured to share information of registered member accounts with a merchant account to accomplish the online purchase transaction. The merchant account may be configured to process credit card transactions.

The system may also include an electronic receipt generator as part of the payment processing component. The electronic receipt generator is configured to send a message to the individual social network user making the purchase within the social network environment when the online purchase transaction is successful. The message may be a private message viewable only by the individual social network user making the purchase.

The system may further include one or more error detection components configured to assist an individual trying to make a purchase. The error detection component may be part of the search engine or scanner and may be configured to monitor one or more posts of a particular user or group(s) of users for typographical errors in the particular string of characters that indicates the user's intent to purchase the product. The error detection component may be part of the payment processing component and may be configured to prompt the user to re-enter payment information if the payment information cannot be validated initially or cannot be validated at the point of purchase.

According to a further aspect of the system, the post on a social networking website configured to both initiate and complete the online purchase transaction of a social network user having a registered member account with a compatible payment processor for that social network website, is viewable by at least one other user of the same social network, such that another user sees the post that initiated and completed the online purchase transaction without seeing the payment information.

According to another aspect of the invention, provided is a method for purchasing a product online within a social network environment that includes posting of one or more characters on a social networking website newsfeed, webpage, or as a status update and thereby purchasing a product. The method may further include prompting a user attempting to make an online purchase by posting to sign-up for a payment processing account. The method may further include searching of posts of a particular user or group(s) of users on the social networking website for a particular string of characters that indicates a user's intent to purchase a product. The method may further include offering the product to a prospective purchaser by an offer posting that provides a string of characters that must be posted or re-posted to purchase the product.

According to still another aspect of the invention, a method is provided for selling or offering to sell a product online within a social network environment that includes offering a product for sale, by posting a string of one or more characters, on a social networking website newsfeed, webpage, or as a status update, or by sending a direct message including the string of one or more characters to another user of the social network, such that the product is purchased by a user of the social networking website posting or re-posting the string of characters. The method may also include providing a universal resource locator (URL) address or a tiny URL address that links to a website featuring the product in the posting or message that offers the product.

It is yet another aspect, advantage, embodiment and objective of the present invention to provide a sales system for use with a social network, the social network having a plurality of users including first and second users having respective first and second unique social network identifiers associated with them, the social network offering such users the ability to post to the social network, the sales system comprising:

a search module operative to monitor such social network for a first post having therein a first string of characters, the search module having stored therein the first string of characters, the first string of characters associated with the first user's intention to purchase a first product/service, the search module stored in a non-volatile memory of a microprocessor;

a payment processing module associated with such first user, the payment processing module having stored therein first financial data of such first user, the payment processing module operative to use the first financial data of such first user to pay for the first product/service;

the sales system operative to cause activation of the payment processing module if a first test is passed;

a shipping/performance module operative to ship/perform the first product;

the payment processing module operative to cause activation of the shipping/performance module.

And it is yet another aspect, advantage, embodiment and objective of the present invention to provide a sales system wherein the shipping of the first product/service further comprises of one member selected from the group consisting of: physically shipping the first product to such first user, physically shipping the first product to a first destination selected by such first user, electronically transferring the first product to such first user, electronically transferring the first product to a second destination selected by such first user, physically performing the service at a third destination selected by such first user, and combinations thereof.

It is yet another aspect, advantage, embodiment and objective of the present invention to provide a sales system further comprising:

a customer validator operative to carry out the first test, in which the first test is checking such first user's unique social network identifier against a list of registered members of the sales system, the first test passed if the first user's unique social network identifier is on the list of registered members of the sales system;

the sales system further operative to activate the payment processing module without further input from such first user if the first test is passed.

It is yet another aspect, advantage, embodiment and objective of the present invention to provide a sales system wherein the first financial information further comprises one member selected from the group consisting of: a credit card number, a credit card security code, a credit card billing address, a credit card name, a bank account number, a bank routing number, other financial data, the first address for the physical shipping of the first product, the third address for the aforementioned physical step of performing a service, a demographic datum, an electronic commerce history and combinations thereof.

Thus it is yet another aspect, advantage, embodiment and objective of the present invention to provide a sales system further comprising:

a user registration module;

the sales system operative to activate the user registration module if the first test is not passed;

the user registration module operative to prompt such first user for the first financial information, receive, store and associate the first financial information with such first user.

Thus it is yet another aspect, advantage, embodiment and objective of the present invention to provide a sales system wherein the user registration module is further operative to extract data from such social network thereby obtaining the first financial information, and further operative to receive, store and associate the first financial information with such first user.

Thus it is yet another aspect, advantage, embodiment and objective of the present invention to provide a sales system further comprising:

a payment information validator whereby such first user can be confirmed by entry of valid financial data.

In addition to which, it is yet another aspect, advantage, embodiment and objective of the present invention to provide a sales system wherein the sales system is further operative to tokenize and securely store the valid financial data.

And furthermore, it is yet another aspect, advantage, embodiment and objective of the present invention to provide a sales system wherein the payment processing module is configured to share information of registered member accounts with a merchant account to pay for the first product/service.

And it is yet another aspect, advantage, embodiment and objective of the present invention to provide a sales system wherein the merchant account is configured to process credit card transactions.

Thus it is yet another aspect, advantage, embodiment and objective of the present invention to provide a sales system further comprising:

an electronic receipt module operative to send a message to such first user, by way of the social network, the message comprising a receipt for the payment.

It will be under that it is yet another aspect, advantage, embodiment and objective of the present invention to provide a sales system wherein the message is a private message viewable only to such first user and not to such second user.

So it is yet another aspect, advantage, embodiment and objective of the present invention to provide a sales system further comprising: an error detection component.

And yet another aspect, advantage, embodiment and objective of the present invention is to provide a sales system wherein the error detection component is operative to recognize a typographical error in a post by such first user, the post comprising one member selected from the group consisting of: the first string of characters, other posts made by such first user while making the purchase, and combinations thereof.

Thus it is yet another aspect, advantage, embodiment and objective of the present invention to provide a sales system wherein the error detection component is operative to prompt such first user to re-enter the first financial data if such data cannot be validated during the purchase.

And it is yet another aspect, advantage, embodiment and objective of the present invention to provide a sales system wherein the error detection component is operative to prompt such first user to re-enter the first financial data if such data cannot be validated during the entry of valid financial data.

It is yet another aspect, advantage, embodiment and objective of the present invention to provide a sales system wherein the first post is viewable by such second user via such social network, but where the first financial data associated with such first user is not viewable by such second user.

It is yet another aspect, advantage, embodiment and objective of the present invention to provide a sales method for use with a social network, the social network having a plurality of users including first and second users having respective first and second unique social network identifiers associated with them, the social network offering such users the ability to post to the social network, the sales method comprising the steps of:

monitoring such social network for a first post having therein a first string of characters, the first string of characters associated with such first user's intention to purchase a first product/service;

after locating the first post, using first financial data associated with such first user to complete a first sale of the first product/service;

shipping/performing the first product/service.

And it is yet another aspect, advantage, embodiment and objective of the present invention to provide a sales method further comprising:

if after locating the first post containing such first string of characters, no financial data associated with such first user is available, then prompting such first user to provide such first financial data.

Thus it is yet another aspect, advantage, embodiment and objective of the present invention to provide a sales method further comprising:

initially offering to such first user the first product/service in a post which further includes the first string of characters such first user must use to indicate such first user's intention to purchase the first product/service.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a block diagram illustrating the flow of possible modules and steps in a method according to a preferred embodiment and best mode of the invention.

FIG. 2 is a schematic diagram of the components of a system according to an embodiment of the invention.

FIG. 3 is a flow chart of possible steps of a purchase according to the method of the invention.

FIG. 4 is a flow chart of possible steps of a registration according to the method of the invention.

FIG. 5 is an exemplary record according to an embodiment of the invention.

FIG. 6 is a UML diagram, activity sub-type, of the steps of the invention, showing the massive parallel concurrency of the method of the invention.

JASON, I'd like to make a FIG. 7, just a block diagram showing the different modules of the system. Could you give me a list of the modules? I gleaned some from the original disclosure, but I'd like a more complete list before I make FIG. 7?

### INDEX OF THE REFERENCE NUMERALS

TABLE One

| | |
|---|---|
| Sales system/first embodiment | 100 |
| Social Network | 102 |
| Post | 104 |
| User | 106 |
| First string of characters/intention | 108 |
| Indicator (for example, hashtag) | 110 |
| Monitor module | 112 |
| String of characters/purchase intention | 114 |
| Match? | 116 |
| No, but typo of first string | 118 |
| Reply | 120 |
| Instruction to insert correct string | 121 |
| Yes, matches first string | 122 |
| Validation/validator module | 124 |
| Unique Social Network ID of user | 126 |
| Valid customer/match | 128 |
| Payment processor module/match | 130 |
| No match | 132 |
| Registration module/prompt | 134 |
| Login credentials | 136 |
| Validation | 138 |
| No credit card validation | 140 |
| Financial data (billing address) | 142 |
| Credit card validation | 144 |
| Virtual shopping cart | 146 |
| Purchase processed | 148 |
| Merchant account | 150 |
| Valid charge? | 152 |
| Approval | 154 |
| No credit card charge approval | 156 |
| Message/post charge disapproval | 158 |
| Reprocess order | 160 |
| Approval message | 162 |
| Approval | 164 |
| Funds | 166 |
| Online seller | 168 |
| Social network | 300 |
| User posts 1^{st} string of characters | 302 |
| Valid user and financial data? | 304 |
| Confirmation prompt/post/msg | 306 |
| User confirms? | 308 |
| Financial data to merchant account | 310 |
| Enrollment offer | 400 |
| User acceptance | 402 |
| Providing financial data or access | 404 |
| Store, associate with social network ID | 406 |
| Purchase now? | 408 |
| Social Network #1 | 501 |
| Social network name | 502 |
| Network #1 Unique Identity | 503 |
| User handle | 504 |
| Social Network #2 | 505 |
| Social network name | 506 |
| Network #2 Unique Identity | 507 |
| User handle | 508 |
| Social Network #3 | 509 |
| Network #3 Unique Identity | 510 |
| Email | 511 |
| User email address | 512 |
| SKYPE ® ID | 513 |
| Skype name | 514 |
| Credit Card #1 | 515 |
| Card number | 516 |
| CCV Code #1 | 517 |
| CCV number | 518 |
| CC Billing | 519 |
| Address | 520 |
| CC Name #1 | 521 |
| CC billing name of user | 522 |
| Credit Card #2 | 523 |
| Card number | 524 |
| CCV Code #2 | 525 |
| CCV number | 526 |
| CC Billing | 527 |
| Address | 528 |
| CC Name #2 | 529 |
| CC billing name of user | 530 |
| Bank Account # | 531 |
| Bank account number of user | 532 |
| Bank Routing # | 533 |
| Routing number of user's bank | 534 |
| Shipping address | 535 |
| User address for shipping | 536 |
| Performance address | 537 |
| Address for performance of service | 538 |
| Buying history | 539 |
| Code representing pas purchases | 540 |
| Advertisement on Social Network | 600 |
| Users see advertisements/posts | 602 |
| Monitoring posts | 604 |
| Financial data to merchant acct | 610 |
| Register new user | 612 |
| Sales system/second embodiment | 1000 |
| Search engine/scanning module | 1100 |
| Payment processor module | 1200 |
| Social network | 1300 |

### DETAILED DESCRIPTION OF EMBODIMENTS

Briefly and in general terms the present invention provides a system that facilitates online purchase transactions within social network environments by enabling online consumers to checkout quicker and more easily through a simply posting to their profile page, newsfeed, or status update. The system includes a search engine and a payment processing component. The search engine monitors the posts on one or more social networks in search of particular strings of characters that indicates a social network user's intent to purchase a product. The search engine may be limited to monitoring a particular group of users or all users on a social network. For example, the search engine may limit itself to monitoring the accounts of social network users that receive an offer message from an online merchant user account or to the followers, connections, or friends of a merchant that posts an offer.

According to another embodiment, the present invention also provides a method for purchasing a product online within a social network environment. The method involves posting one or more characters on a social networking website newsfeed, webpage, or as a status update and thereby purchasing a product. This posting of a particular string of characters by social network users desiring to purchase a particular product may be done in response to the offer of a product as learned about via direct message on the social network from the merchant or a marketer thereof, or by a posting or status update from the merchant or marketer that the prospective purchaser sees on the social network, or by other medium. The offer includes the instructions or string of characters that must be entered by the users to effectuate the purchase transaction. The user desiring to purchase would have to register with a payment processor company after typing the string of characters if he/she is not already pre-registered. The payment processor company would have credit card or other payment information from the user affiliated with that user's social network handle or unique account identifier.

According to a further embodiment, aimed at the perspective of merchants and online sellers, the present invention provides a method for selling or offering to sell a product online within a social network environment. The method includes offering a product for sale, by posting a string of one or more characters, on a social networking website newsfeed, webpage, or as a status update, or by sending a direct message to one or more users that includes the string of one or more characters along with the offer. The product is subsequently purchased by users of the social networking website who saw the post/update or received the message by the users posting or re-posting the string of characters.

This system and method are particularly (although certainly not exclusively) well-suited for flash sales involving a limited number of goods. For example, celebrity autographed merchandise, concert tickets, or limited edition products. This is so due to time being of utmost essence to prospective purchasers in these transactions. That is, if the prospective purchaser cannot act and pay fast enough the goods will be gone. By expediting the ability of a purchaser who is pre-registered with the novel payment system described herein to checkout nearly instantaneously with the decision to buy and posting to that effect, the present invention puts these pre-registered purchasers in a superior possession for taking advantage of flash sales of limited goods.

The system and method described herein are amenable to incorporation on any social networking website including but not limited to Twitter, Pinterest, Facebook, Linkedin, etc. A single payment processor, e.g. “Post2 Pay” may be designed to work with any one of these social networking websites to facilitate purchasers by posting or different payment processors (e.g. “Twt2 Pay”, “Pin2 Pay”, etc.) may be designed to work with specific social networking websites (e.g. exclusively Twitter, Pinterest, etc.).

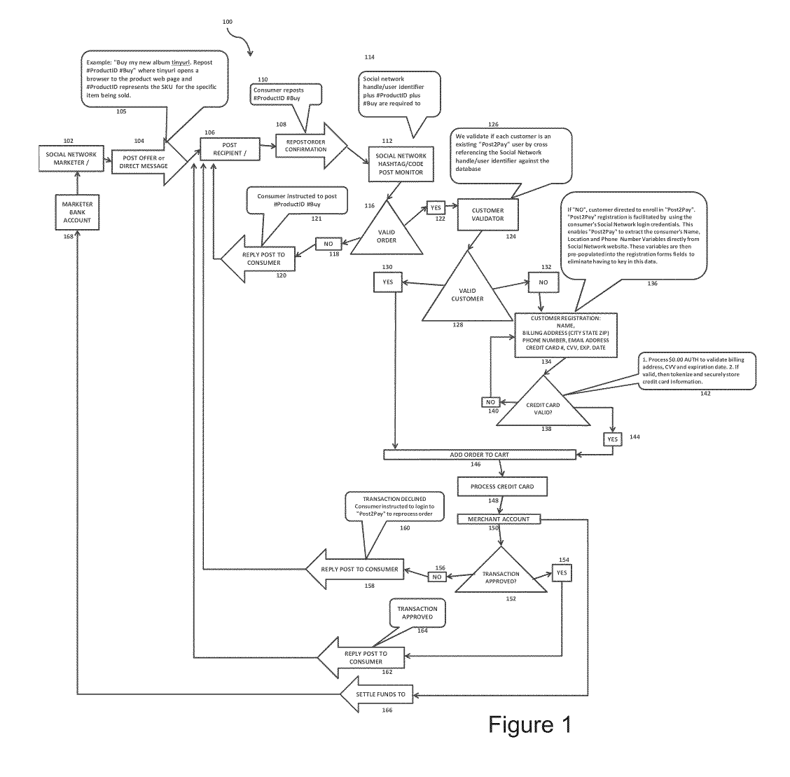

Referring now to the accompanying FIG. 1, a first embodiment 100 of the invention is provided as a method beginning with an online seller who wants to sell something online through a social network 102. The online seller then posts 104 an offer that other users 106 of the social network see. Alternatively, the online seller may direct message the offer to all or particular users or groups of users of the social network. If a social network user that sees the post or message and desires to purchase the product or service offered the social network user simply posts 108 a particular string of characters that was provided in the offering post or message. For example, the particular string of characters may be preceded by a hashtag symbol “#” or other indicator 110.

Next, a hashtag or code monitor 112 of posts on the social network identifies each instance of the particular string of characters provided in the offer for purchasing or each time a user posts this string. For example, the purchaser may post “#ProductID #Buy” 114 to purchase if that is the string provided in the offer. The hashtag or code monitor may be part of a search engine or scanner operated by a third party payment processor (e.g. “Post2 Pay”, “Twit2 Pay”, “Pin2 Pay”, etc.). The hashtag or code monitor determines 116 whether a string of characters matches the string provided in the offer to purchase a product/service (“Yes”) 122 or not (“No”) 118 but resembles a string very close thereto. If a string posted by a potential purchaser is close to but does not exactly match the string in the offer, a reply 120 is sent to the social network user in which the social network user is instructed to post the correct string 121.

If the string posted by a social network user exactly matches the string provided in the offer and the social network user has a valid handle or unique account identifier, then the customer is validated 124 to determine whether the social network user is already registered with the payment processor. For example, the third party payment processor would scan their database of registered customers searching for the social network handle or unique account identifier on a particular social network to determine whether they already have a registered customer with that handle 126 (e.g. @scl_netwrk_user1, @scl_netwrk_user2, etc.)

If the social network user posting the matching string of characters to the string provided in the offer and thereby indicating an intention to purchase matches a valid customer 128 pre-registered with the payment processor (“Yes”) 130 then the product or service desired is added to a virtual shopping cart of the user 146. If the social network user handle does not match a pre-registered member of the payment processor (“No”) 132 then that social network user is prompted to sign-up 134 on the payment processor's website so that he/she can pay via the streamlined posting method in the future. Registration on the third party payment processor website (e.g. “Post2 Pay”) may be facilitated by using the social network user's social network login credentials 136. This enables the payment processor website to extract the consumer's Name, Location, Phone Number, etc. variables directly from Social Network website. These variables are then pre-populated into the registration forms fields to eliminate time spent from a user having to “key in” this data.

As part of the sign-up process the user is prompted to enter a credit card or other payment information. The payment information must be validated 138 before proceeding, for example by processing a $0.00 or low amount transaction and checking the billing address 142. If the credit card cannot be validated (“No”) 140 the user is prompted to re-enter the credit card info. or another payment method. If the payment information is successfully validated (“Yes”) 144 then the information is tokenized (e.g. encrypted to secure and protect credit card information) and stored in the user's account for future transactions.

To summarize, if the social network user desiring to purchase by posting on a social network is a valid customer of the payment processor and their payment information is valid then the order is added to a virtual shopping cart and the purchase transaction is processed 148 using their payment source. A merchant account 150 for the particular payment source (e.g. credit card type) may then determine 152 whether a transaction is approved or not. If the transaction is not approved (“No”) 156 then the social network prospective purchaser is sent a direct message or post 158 informing him/her that the transaction was declined and instructed to login to the payment processor again to reprocess the order 160. If the transaction is approved 154 then the social network user/purchaser by posting is sent a direct message or post 162 that his/her transaction was approved 164. Meanwhile the merchant account responsible for the payment or credit card sends the settlement funds 166 from the transaction to the bank account of the online seller 168.

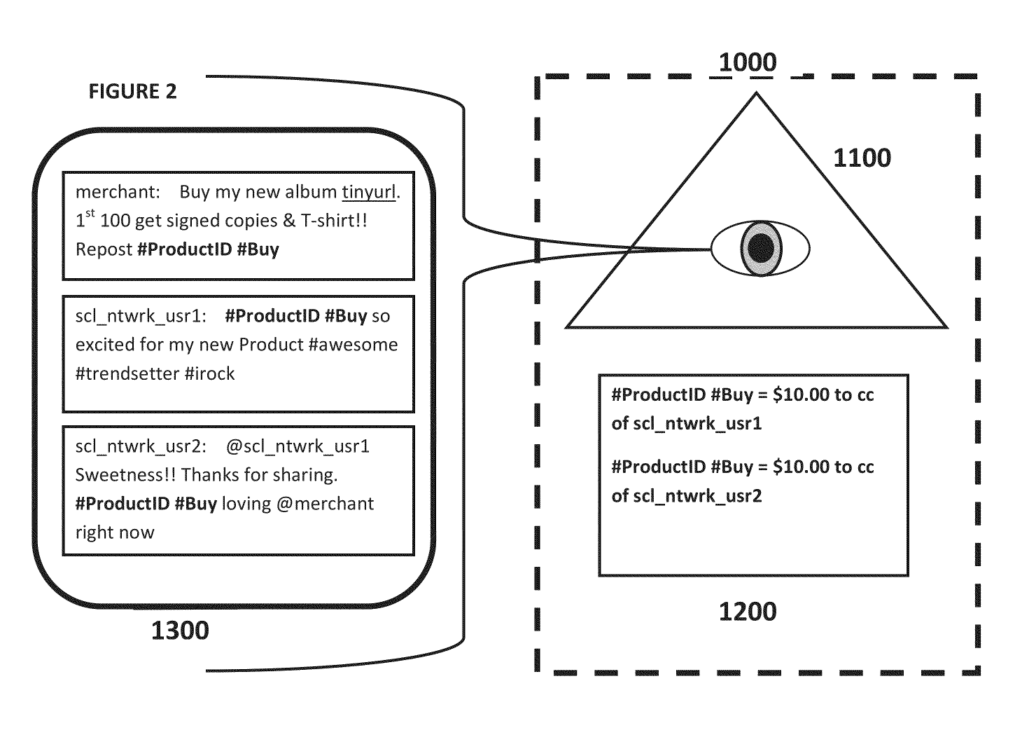

Referring now to the accompanying FIG. 2, a second embodiment 1000 of the invention is provided as a system for facilitating payment by posting on a social network. The system includes a search engine or scanning device 1100 responsible for monitoring activity on a social network 1300. The search engine or scanning device looks for instances of when a particular string of characters (e.g. #ProductID #Buy) posted in an offer (e.g. the initial post by social network handle “merchant”) are posted and re-posted by social network users (e.g. handles “scl_ntwrk_usr1” and “scl_ntwrk_usr2”) desiring to purchase the product offered. The system further includes a payment processor component 1200 that may include any number of elements for ensuring payments are made by the social network users by correlating payment system accounts with particular social network user accounts. The payment processor component may also keep track of all of this data about who has purchased a particular product for later providing to online sellers.

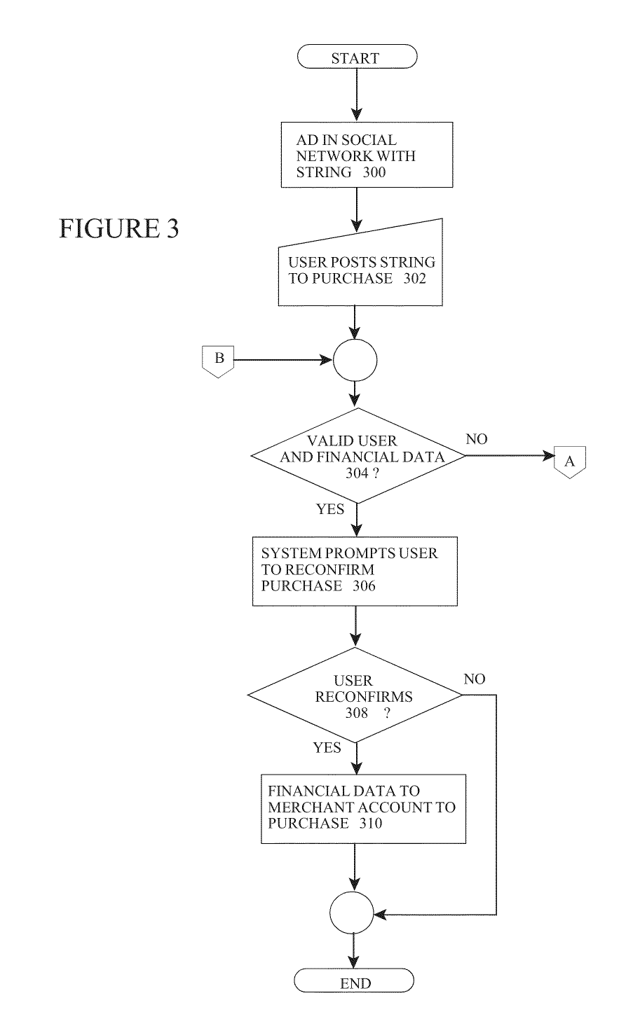

FIG. 3 is a flow chart of possible steps of a purchase according to the method of the invention.

In this alternative embodiment of the invention, the process is depicted as a streamlined easy to use method for a social network user to make a purchase with very little bother.

Social network 300 may be any of the networks described previously or any other social network now known or later developed.

The user (presumably in response to seeing a post by another user about a purchase) posts the 1st string of characters 302, which from the standpoint of the user is nearly the entire effort required to make a purchase. Thus, as noted previously, impulse purchases, private purchases in groups and so on are greatly facilitated.

A check is then performed for valid user and financial data, step 304. Obviously if the user is not a registered member with financial data on file, a purchase becomes impossible, and the same applies if some other invalidity is noted. If the user is not a member, they are immediately switched (“A”) to the registration process, thus enabling them to make the sale after registration and obtaining a new member for the purchasing service.

Confirmation prompt/post/msg 306 is then provided to the user. This is necessary simply to avoid accidental purchases by users, however, this prompt may be simplified greatly.

If the user confirms at step 308, for example by pushing a soft button, reposting the character string, etc, then from the user's perspective the purchase has been accomplished (assuming successful payment occurs in the next steps).

Financial data of the first user is sent to a merchant account at step 310, and shipping of the item then follows.

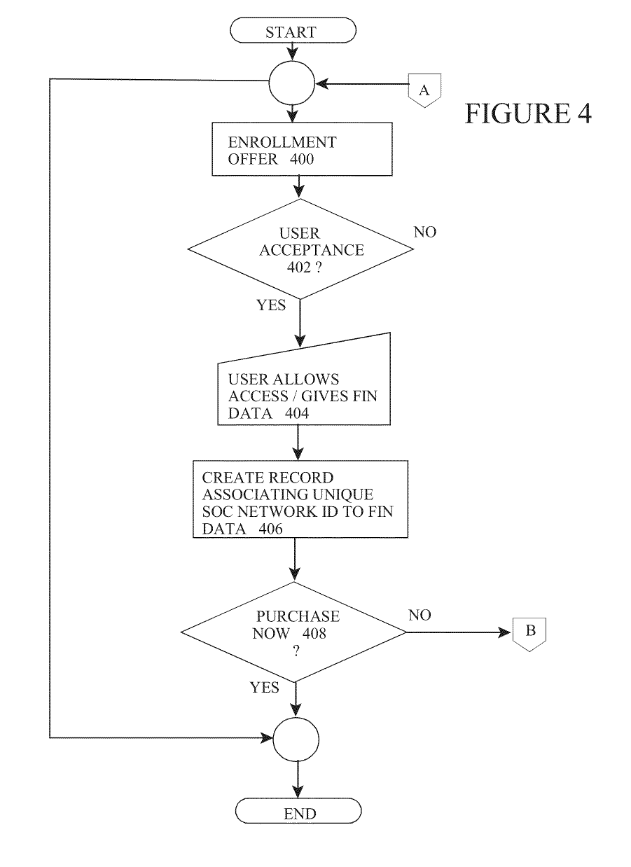

FIG. 4 is a flow chart of possible steps of a registration according to the method of the invention.

Enrollment offer 400 may come from at least two different sources: it may arrive from a failed purchase attempt (“A”) in which the user is now being offered a chance to register and become a member, or it may come from a source such as an advertisement, a social wall, a website and so on.

User acceptance step 402 establishes that the user wishes to enroll. Obviously some users who were attempting to make a purchase may leave when confronted by registration, so it is desirable to make registration as quick as possible.

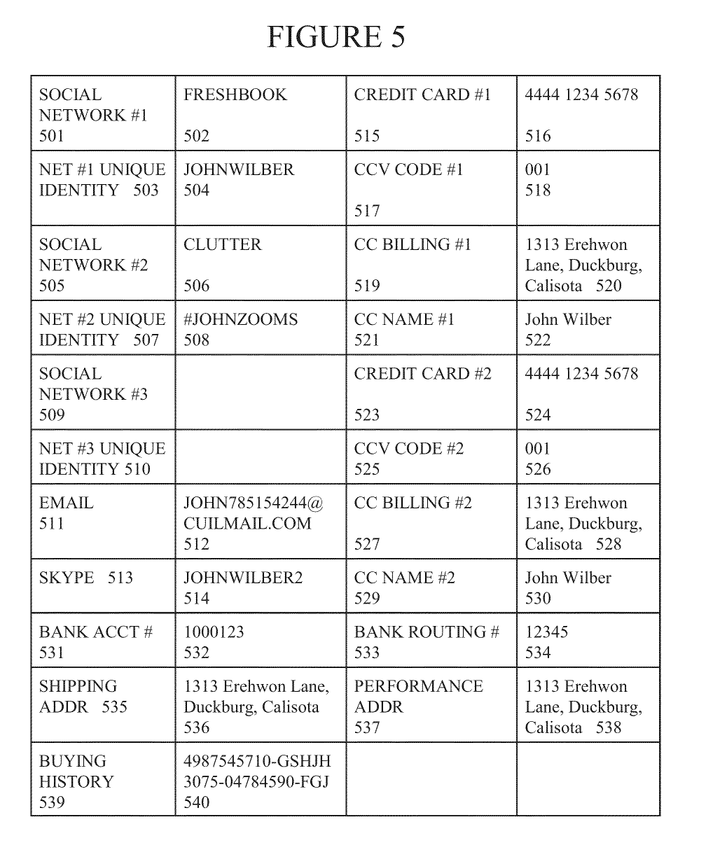

Providing financial data or access 404 is crucial: the user may take the traditional path of entering financial information such as that in FIG. 5, or the user may have financial information already on file with the social network. In the latter case, registration may be as simple as allowing access to the financial data already in the social network server.

Once the financial data is obtained, it is stored and associated with the users social network ID 406, the unique handle by which the user is known in Pinterest or Twitter or whatever.

“Purchase now?” query, step 408, allows a user who has registered after coming from an attempt to purchase (FIG. 3) to return to the process of buying. This greatly eases the purchase, of course, since the user need not find the original posting from another user or the original advertisement.

FIG. 5 is an exemplary record according to an embodiment of the invention. As may be seen, there are diverse items of information. In FIG. 5, each item has been presented as being different than its respective label. Thus the name of social Network #1 (item 501) is presented as if stored separately, (social network name, data field 502). However, in use it is more likely that the data will be compressed and encoded and simply by use of data structures, the odd numbered items may not be needed in preferred embodiments. However, it is presented in this format for human clarity.

Network #1 Unique Identity 503 is simply the user handle stored in data structure 504, that is, the user's name in their social network.

Social Network #2, 505, having social network name, 506, network #2 unique identity 507, user handle 508 and so on is simply a second network, as most social network users belong to two or more such networks. The same goes for social network #3 509, network #3 unique identity, 510 and so on. (Note that this user, John Wilber, does not belong to a 3^{rd} Social network, so two fields are omitted.)

Email 511 and user email address 512, as well as SKYPE® ID 513 (being Skype® name 514) are more traditional communication methods.

Credit card #1 515, having card number 516, CCV code #1 517 stored in CCV number field 518, and CC billing address 519 stored in field 520, combine with the person's name (fields 521, 522) to provide a complete set of financial data which can be used to make a purchase within the system simply by transferring the information to a merchant account for settlement.

A secondary credit card may be used, thus there is credit card #2 (523, card number 524, CCV Code #2 (525, 526), CC billing address (527, 528) and the cardholder's name (529, 530) make a second known payment method for the sales system to use.

Additional financial and shipping information (since the invention includes the physical step of shipping the produce/performing the service) may include but not be limited to bank account #, field 531, 532, the bank's routing number 533, 534, the user's shipping address in fields 535, 536 and/or performance address 537, 538 for performance of services ordered by the method of the invention, and so on.

Additional valuable information may include buying history (data structures 539, 540) and so on.

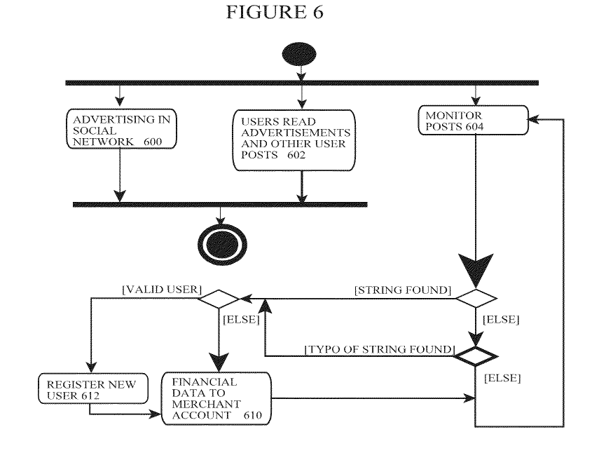

FIG. 6 is a UML diagram, activity sub-type, of the steps of the invention, showing the massive parallel concurrency of the method of the invention. In particular, it will be seen that three activities may occur simultaneously. One is advertisement on the social network 600, which comes in the form of paid advertising and of course in posting, by a first user, of the fact that they bought a particular first product (which posting does not show their financial information but does provide the first string of characters so other users can post/repost the string and purchase the product for themselves)

Users see advertisements/posts 602 in the normal course of using the social network. Finally, the system may be constantly monitoring posts 604. Note that this particular UML activity diagram does not include a termination to the cross-bar beneath steps 600 and 602, however, it will be understood that this is for clarity: the monitoring step may terminate at a time of choosing of the seller.

Financial data to merchant account 610, registration of new user 612 and so on are as previously discussed.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A sales system for use with a social network, the social network having a plurality of users including first and second users having respective first and second unique social network identifiers associated with them, the social network offering such users the ability to post to the social network, the sales system comprising:
a search module operative to monitor such social network for a first post having therein a first string of characters, the search module having stored therein the first string of characters, the first string of characters associated with the first user's intention to purchase a first product/service, the search module stored in a non-volatile memory of a microprocessor;
a payment processing module associated with such first user, the payment processing module having stored therein first financial data of such first user, the payment processing module operative to use the first financial data of such first user to pay for the first product/service;
the sales system operative to cause activation of the payment processing module if a first test is passed;
a shipping/performance module operative to ship/perform the first product;
the payment processing module operative to cause activation of the shipping/performance module.

2. The sales system of claim 1, wherein the shipping of the first product/service further comprises of one member selected from the group consisting of: physically shipping the first product to such first user, physically shipping the first product to a first destination selected by such first user, electronically transferring the first product to such first user, electronically transferring the first product to a second destination selected by such first user, physically performing the service at a third destination selected by such first user, and combinations thereof.

3. The sales system of claim 2, wherein the sales system further comprises:
a customer validator operative to carry out the first test, in which the first test is checking such first user's unique social network identifier against a list of registered members of the sales system, the first test passed if the first user's unique social network identifier is on the list of registered members of the sales system;
the sales system further operative to activate the payment processing module without further input from such first user if the first test is passed.

4. The sales system of claim 1, wherein the first financial information further comprises one member selected from the group consisting of: a credit card number, a credit card security code, a credit card billing address, a credit card name, a bank account number, a bank routing number, other financial data, the first address for the physical shipping of the first product, the third address for the aforementioned physical step of performing a service, a demographic datum, an electronic commerce history and combinations thereof.

5. The sales system of claim 3, wherein the sales system further comprises:
a user registration module;
the sales system operative to activate the user registration module if the first test is not passed;
the user registration module operative to prompt such first user for the first financial information, receive, store and associate the first financial information with such first user.

6. The sales system of claim 5, wherein the user registration module is further operative to extract data from such social network thereby obtaining the first financial information, and further operative to receive, store and associate the first financial information with such first user.

7. The sales system of claim 5, further comprising:
a payment information validator whereby such first user can be confirmed by entry of valid financial data.

8. The sales system of claim 7, wherein the sales system is further operative to tokenize and securely store the valid financial data.

9. The sales system of claim 8, wherein the payment processing module is configured to share information of registered member accounts with a merchant account to pay for the first product/service.

10. The sales system of claim 9, wherein the merchant account is configured to process credit card transactions.

11. The sales system of claim 7, further comprising:
an electronic receipt module operative to send a message to such first user, by way of the social network, the message comprising a receipt for the payment.

12. The sales system of claim 11, wherein the message is a private message viewable only to such first user and not to such second user.

13. The sales system of claim 12, further comprising: an error detection component.

14. The sales system of claim 13, wherein the error detection component is operative to recognize a typographical error in a post by such first user, the post comprising one member selected from the group consisting of: the first string of characters, other posts made by such first user while making the purchase, and combinations thereof.

15. The sales system of claim 13, wherein the error detection component is operative to prompt such first user to re-enter the first financial data if such data cannot be validated during the purchase.

16. The sales system of claim 13, wherein the error detection component is operative to prompt such first user to re-enter the first financial data if such data cannot be validated during the entry of valid financial data.

17. The sales system of claim 1, wherein the first post is viewable by such second user via such social network, but where the first financial data associated with such first user is not viewable by such second user.

18. A sales method for use with a social network, the social network having a plurality of users including first and second users having respective first and second unique social network identifiers associated with them, the social network offering such users the ability to post to the social network, the sales method comprising the steps of:
monitoring such social network for a first post having therein a first string of characters, the first string of characters associated with such first user's intention to purchase a first product/service;
after locating the first post, using first financial data associated with such first user to complete a first sale of the first product/service;
shipping/performing the first product/service.

19. The sales method of claim 18, further comprising:
if after locating the first post containing such first string of characters, no financial data associated with such first user is available, then prompting such first user to provide such first financial data.

20. The sales method of claim 19, further comprising:
initially offering to such first user the first product/service in a post which further includes the first string of characters such first user must use to indicate such first user's intention to purchase the first product/service.
